(19) United States
(12) Patent Application Publication
(10) Pub. No.: US 2009/0061787 A1
(43) Pub. Date: Mar. 5, 2009

(54) TRANSCEIVER, RF-TRANSCEIVER, COMMUNICATION SYSTEM AND METHOD FOR TRANSFERRING CONTROL PACKETS

(76) Inventors: Rainer Koller, Linz (AT); Burkhard Neurauter, Linz (AT); Friedrich Seebacher, Leonding (AT); Jorn Angel, Bochum (DE); Dietmar Wenzel, Munchen (DE); Bernhard Leitner, St. Martin (AT)

Correspondence Address: ESCHWEILER & ASSOCIATES LLC, 629 EUCLID AVENUE, SUITE 1000, NATIONAL CITY BUILDING, CLEVELAND, OH, 44114, US

(21) Appl. No.: 11/848,002

(22) Filed: Aug. 30, 2007

(51) Int. Cl. H04B 1/38

(52) U.S. Cl. 455/73

(57) ABSTRACT

The present invention refers to an RF-transceiver and to a communication system. The invention is also related to a method for transmitting and processing control packets, particularly control packets transmitted by a baseband device to an RF-transceiver.

### FIELD OF THE INVENTION

The present invention is related to a transceiver, an RF-transceiver and to a communication system. The invention is also related to a method for transmitting and processing control packets, particularly control packets transmitted by a baseband device to an RF-transceiver.

### BACKGROUND

Mobile communication systems and user devices are becoming increasingly complex due to the user demand of transmitting and receiving RF-signals according to different communication standards. Such mobile communication systems may include mobile phones, PDA's, laptops, palmtops, mobile game consoles and the like. In addition, current users require smaller communication systems, which may use highly integrated circuitry.

Current communication systems may comprise different devices and elements for signal generation, transmission and reception. For instance, very often user side signal processing and baseband signal generation are combined in a baseband device integrated on a single semiconductor chip. Accordingly, signal transmission, signal reception and pre-processing of received signals may be combined in an RF-transceiver chip separated from any baseband components. Such RF-transceiver chip may comprise one or more signal paths for receiving and transmitting RF signals. Those paths may include switches, duplexers, pre-amplifiers in the receiving paths and power amplifiers in the transmitter paths, respectively. Recently, RF-transceiver chips sometimes include separate signal paths for signal generation for several different mobile communication standards. Furthermore, carrier signals are generated in the RF-transceiver chips in accordance with a mobile communication standard selected by the user or the baseband device.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention improves the communication between a baseband device and a transceiver device allowing a self-autonomous controlling of the transceiver device. In accordance with one embodiment of the present invention, the amount of information provided by the baseband device to the transceiver device may be reduced, thereby relaxing the requirement for a timely critical communication between the baseband device and the transceiver device. Further, configuration of the transceiver is at least partly done within the transceiver device. The control structure between the transceiver and the baseband device may become separated and more flexible, resulting in an easier implementation and development of both devices.

In one embodiment, a transceiver having a plurality of sub-circuits comprises an interface to receive control packets, those control packets specifying at least one mode of operation of the transceiver. The transceiver also comprises a memory configured to store a first plurality of configuration patterns, at least one configuration pattern of the first plurality of configuration patterns configuring the transceiver for the at least one mode of operation. A control interface is coupled to the plurality of sub-circuits. The transceiver also comprises a decoder coupled to the interface and to the memory. The decoder is adapted to retrieve the at least one configuration pattern out of the memory in response to the control packet and provide the at least one configuration pattern at the control interface.

Using a plurality of specific configuration patterns stored in the memory results in a transparent and flexible control procedure of the transceiver. Further, the plurality of configuration patterns stored in the memory allows selection of different operating states of one or more sub-circuits of the transceiver.

If a mode of operation of the transceiver is specified by the control packet, the decoder may, in one embodiment, process the control packet and retrieve the required configuration pattern in response to the processed control packet. The configuration pattern provided at the control interface configures the sub-circuits of the receiver in accordance with a requirement set forth by the control packet or the information therein. Therefore, it is not required that the baseband device be programmed to configure the internal procedures of the transceiver. Rather, it is sufficient to specify a desired mode of operation of the transceiver by the control packet.

In a further embodiment, an RF-transceiver comprises a plurality of circuit elements to receive and/or transmit one or more RF-signals. At least one circuit element is configurable in response to an adjustment signal. The RF-transceiver comprises a register configured to store a first plurality of configuration patterns, at least one configuration pattern of the first plurality of patterns specifying a configuration of the at least one circuit. Finally, a controller is coupled to the memory and adapted to retrieve the at least one configuration pattern in response to a request signal. It is further adapted to provide an adjustment signal dependent on the at least one configuration pattern.

In yet another embodiment, an RF-transceiver comprises an interface to receive a control packet, wherein the control packet comprises at least one configuration pattern. A memory is configured to store a plurality of configuration patterns, at least one configuration pattern thereof specifying a configuration of at least one circuit of the RF-transceiver. A controller is coupled to the memory and to the interface, and is adapted to receive the control packet and store the at least one configuration pattern within the control packet in the memory.

### BRIEF DESCRIPTION OF THE DRAWINGS

In the following, different aspects and embodiments will be explained in greater detail hereafter with reference to the accompanying drawings in which

FIG. 1 illustrates an RF-transceiver according to an embodiment,

FIG. 2 shows a schematic view illustrating the signal flow for a communication system according to an embodiment,

FIG. 3 shows a portion of an RF-transceiver in the communication system according to the embodiment shown in FIG. 2,

FIG. 4 illustrates a schematic view of parts of a communication system and a corresponding signal flow according to an embodiment,

FIG. 5 shows a further schematic view illustrating parts of a communication system and a corresponding signal flow according to an embodiment,

FIG. 6 shows a schematic view of units and a signal flow according to an embodiment,

FIG. 7 illustrates a memory and its content in a transceiver according to an embodiment,

FIGS. 8 and 9 illustrate an embodiment of a method for controlling a transceiver and transmitting a signal.

### DETAILED DESCRIPTION OF THE INVENTION

In the following description, further aspects and embodiments of the present invention are disclosed. In addition, reference is made to the accompanying drawings, which form a part hereof, and in which is shown by way of illustration in which the invention may be practiced. The embodiments of the drawings present a discussion in order to provide a better understanding of one or more aspects of the present invention. The disclosure is not intended to limit the features or key elements of the invention to a specific embodiment. Rather, the different elements, aspects and features disclosed in the embodiments can be combined in different ways by a person skilled in the art to achieve one or more advantages of the present invention. It is to be understood that other embodiments may be utilized and structural or logical changes may be made without departing from the scope of the invention. The elements of the drawings are not necessarily to scale relative to each other. For illustration purposes, some telecommunication standards are specified. Further, some communication standards for communicating between baseband and RF-transceiver chips are also specified. These communication standards referred to herein are not restricted to the enclosed embodiments. Other communication standards, advanced and subsequent versions of the standards mentioned herein can also be used to achieve different aspects of the present invention. Like reference numerals designate corresponding similar parts.

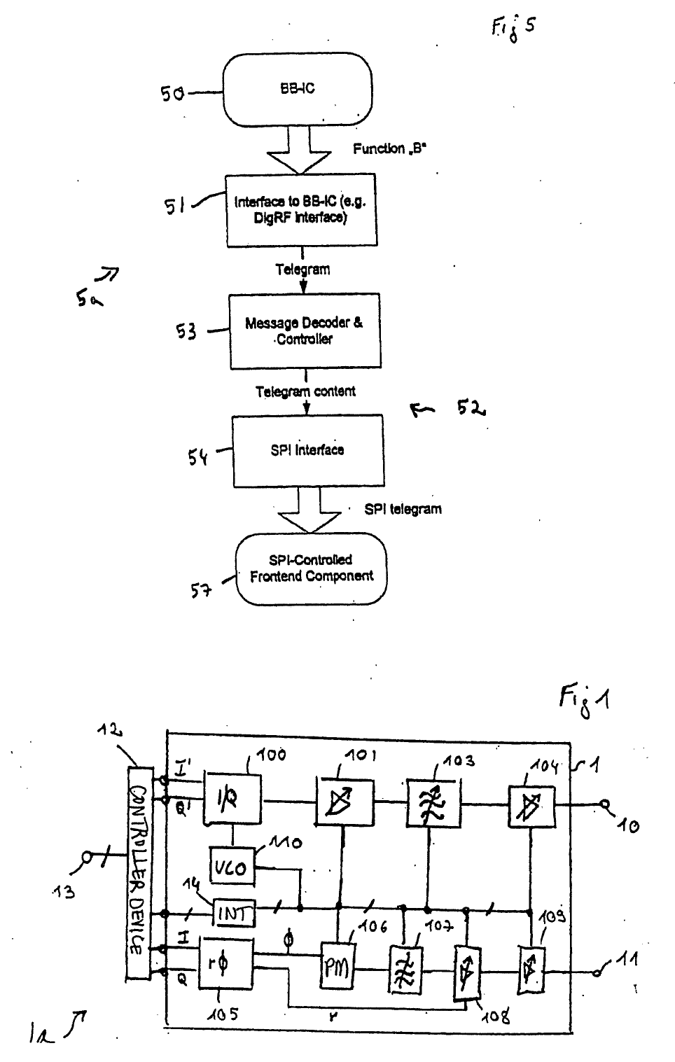

FIG. 1 shows a schematic view of an RF-transceiver la. The RF-transceiver 1a may be implemented in a semiconductor substrate as an integrated circuit comprising a plurality of sub-circuits. In this respect, the term “sub-circuit” may represent a single circuit designed to achieve a single purpose or a group of circuits which may be grouped together, because of some logical or structural connection between. For instance, the sub-circuits can be logically combined in one or more receiver paths and a transmitter path. A phase looked loop, wherein a frequency divider with adjustable frequency ratio, a phase comparator and a voltage controlled oscillator are grouped together is a non-limiting example of a sub-circuit. Such sub-circuit can be part of a further sub-circuit. Also, an amplifier circuit may be grouped together with its supply voltage generator as a sub-circuit within a transmitter or receiver path according to one embodiment.

Sub-circuits may comprise one or more adjustable parameters in order to change the signal processing behavior of the respective sub-circuit. A phase looked loop may represent a non-limiting example for such a sub-circuit, wherein a control voltage for the resonance frequency of a voltage controlled oscillator may represent a first adjustable parameter and the adjustable divider ratio of a frequency divider a second parameter. Supply terminals on the surface as well as signal terminals on the surface of the substrate may provide the integrated circuit with the required supply voltage and current and useful signals, respectively. The RF-transceiver 1a in this embodiment may comprise an RF-transceiver front-end 1 comprising a plurality of sub-circuits used for transmitting and receiving RF-signals.

In this embodiment, the RF-transceiver-front-end 1 comprises one transmitter path and one receiver path. Alternatively, the RF-front-end 1 may comprise more than one transmitter or receiver path. For instance the RF-front-end 1 may comprise a first transmitter path for a first mobile communication standard and a second transmitter path for a second mobile communication standard. The paths may be completely separated or may share one or more sub-circuits. In one embodiment the transmitter path comprises an re-converter 105 having two input terminals for baseband signal components I and Q. The signal components I and Q represent a digital data pattern corresponding to a data content to be transmitted. The I and Q signal components are converted in the rφ-converter 105 to a phase portion 4 and an amplitude portion φ. The phase portion φ is applied to a phase modulator (PM) 106 comprising a phase locked loop. The phase modulation component φ may be used to adjust the frequency divider ratio in the phase locked loop of the phase modulator 106. Adjusting the frequency divider portion results in a phase modulation of the carrier signal provided at the output of the phase modulator 106 and applied to an adjustable band pass filter 107.

The passband of filter 107 can be adjusted externally such that the filter 107 suppresses undesired signal products generated by the phase looked loop, like sub-harmonic, harmonic portions or crosstalk of baseband signal components.

The amplitude portion φ is applied to an adjustable amplifier 108. The amplifier 108 may comprise a programmable gain amplifier (PGA) with discrete amplification gain or a voltage gain amplifier with analog amplification gain. A second input terminal of the adjustable amplifier 108 is connected to the output terminal of the bandpass filter 107. The phase modulated signal applied to the adjustable amplifier 108 is further modulated in response to the amplitude portion r. Finally, the output terminal of the adjustable amplifier 108 is connected to an input terminal of a power amplifier 109. The output of power amplifier 109 may be coupled to a terminal 11 on the surface of the semiconductor. A signal applied thereon is transmitted via an externally arranged antenna (not shown herein) in one embodiment.

The receiver path of the RF-transceiver front-end 1 of the RF-transceiver 1a comprises a terminal 10, on which a signal received by an antenna (not shown herein) is applied. The terminal 10 is connected to a first low-noise amplifier 104. The low-noise amplifier 104 comprises an adjustable gain and a very low noise figure to amplify the received signal without generating additional inter-modulation products or any spurious signals. The low noise amplifier 104 may comprise a single low noise amplifier or an amplifier chain with a plurality of low noise amplifiers connected in series. Some of those amplifiers may comprise an adjustable gain.

The output of the low noise amplifier 104 is connected to an adjustable bandpass filter 103. The passband center frequency of the adjustable bandpass filter 103 may be selected in response to a corresponding control signal. The bandpass filter 103 may also comprise a plurality of single filters in one embodiment, each of them having different and partly overlapping passbands with different center frequencies. Some of those filters may also comprise an adjustable passband. For instance, the filter unit 103 may comprise a plurality of different filters, each of them having a passband in different frequency areas according to a desired communication standard.

The output of the bandpass filter 103 may be coupled to a further amplifier 101 and to an I/Q-demodulator 100. The I/Q-demodulator 100 comprises a local oscillator input connected to a phase locked loop 110. Depending on the received RF-signal and its center frequency, the phase locked loop provides a corresponding local oscillator signal for IQ-demodulation in the I/Q-demodulator 100. The demodulated signal components I′ and Q′ are provided as digital signals at the output terminals of the RF-transceiver front-end. While in this embodiment, only a single receiver path is shown, the RF-transceiver 1a may comprise a plurality of different receiver paths.

The RF-transceiver 1a also comprises a controller device 12 connected to the I/Q-demodulator 100 and the rφ-modulator 105 in the transmitter path. The controller 12 is also coupled to an interface (INT) 14. The interface 14 is connected via a bus to a plurality of sub-circuits in the receiver and transmitter path as shown herein. For instance, the interface 14 is coupled via the bus to the phase locked loop 110, both amplifiers 101 and 104 and to the adjustable filter unit 103 of the receiver path. It is also connected via the bus to the phase modulator and the phase locked loop 106, the adjustable filter 107 and both amplifiers 108, 109 of the transmitter path.

Due to the high amount of data and control/adjustment commands required for processing and controlling the different sub-circuits for the several mobile communication standards, it is useful to select and adjust all sub-circuits in the RF-transceiver front-end 1 by the device circuit 12 autonomously. In this respect, in one embodiment the term “autonomously” means that any baseband circuit connected to the RF-transceiver 1a does not send timely accurate commands to the RF-transceiver for adjusting one or more sub-circuits of the transceiver. Controlling the RF-transceiver front-end and the sub-circuits is achieved by the controller device 12 autonomously. As a result the baseband device does not need to “know” about some specific behavior of the RF-transceiver front-end.

An autonomous control by the controller device 12 in the transceiver 1a allows reducing a timely critical transmission of control commands sent by the baseband unit to the RF-transceiver la. Particularly, the baseband unit may now select the desired mobile communication standard and the desired frequency range and transmission/receiver mode, while the controller device 12 within the RF-transceiver la selects and adjusts the corresponding sub-circuits in response to the “more general” commands sent by the baseband device.

For this purpose, the controller device 12 comprises a memory, in which a plurality of possible configuration patterns is stored. In one embodiment each configuration pattern corresponds to one or more adjustment signals for adjusting one or more sub-circuits for a desired mode of operation. If the baseband device requires a specific mode of operation, for instance a GSM transmitter mode in a specific channel and a specific output power, the controller device 12 selects and retrieves the corresponding configuration patterns from the memory. The required configuration pattern is then provided at the interface 14 and applied to the bus connecting the sub-circuits of the transmitter and receiver paths. Correspondingly, the correct configuration pattern is applied to the sub-circuits, thereby selecting and adjusting the sub-circuits accordingly.

If two or more different subsequent configurations of several sub-circuits of the RF-transceiver front-end 1 are required, the controller device 12 provides the corresponding configuration pattern at the interface 14 in a timely synchronized manner. This will reduce the overhead and particularly the commands sent from the baseband device to the RF-transceiver device. Further, it is not necessary anymore to have a specific knowledge about the internal structure and time synchronization of the RF-transceiver front-end.

In addition, several sub-circuits may require mode and command independent operating states. With the use of the bus system as indicated in the embodiment according to FIG. 1, the sub-circuits may also transmit a service request signal. The service request signal is received by the interface 14 and provided to the controller device 12 for further processing. The controller device 12 can now select a corresponding configuration pattern and provide the configuration pattern to the sub-circuit sending the service request signal.

Alternately, in one embodiment the interface 14 may comprise a small register for storing some configuration patterns, which may be used in short time. After receiving a service request signal the interface may provide the corresponding configuration pattern to the sub-circuit sending the service request signal. This may allow an adjustment of the sub-circuit without any delay due to processing and without additional timing signals. On the other hand, the sub-circuit may request its next configuration as soon as the circuit is finished with the current signal processing.

In the embodiment according to FIG. 1, the controlling of the several sub-circuits of the RF-transceiver front-end is separated from any commands sent by the baseband device. Particularly, the baseband device may transmit general commands for switching into a desired mode of operation. The several adjustments required for the desired mode of operation are controlled by the controller device semi-autonomously using one or more configuration patterns stored in a memory. Those configuration patterns are retrieved from the memory and stored in a register or provided directly at the baseband interface. Further, the controller device 12 or the interface 14 may transmit a configuration pattern for a specific sub-circuit upon request by the sub-circuit.

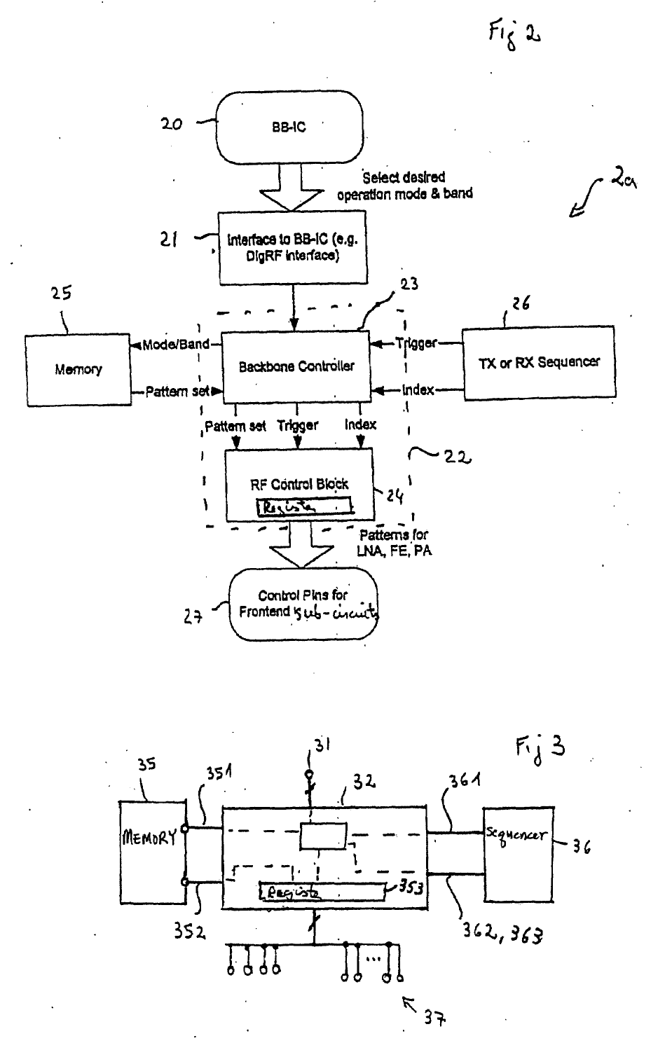

FIG. 2 shows a schematic view of a communication 2a system illustrating several logical and structural devices used for configuring the RF-transceiver front-end and the corresponding signal flow. The communication system 2a comprises a baseband device 20. The baseband device 20 is implemented as an integrated circuit in a semiconductor substrate in one embodiment. It comprises a digital signal processor for processing and preparing the digital data to be transmitted according to a mobile communication standard.

For example, the digital signal processor may generate a plurality of digital I and Q data representing digital I and Q signal components according to the GSM communication standard or the W-CDMA communication standard. Also, the digital signal processor in the baseband device 20 may generate digital signals according to the Bluetooth, the ETSI 802.11a, .11b, .11d, .11g, .11h WLAN standards or the GSM/EDGE mobile communication standard. The baseband device 20 comprises a digital interface connected to a digital interface 21. The interface 21 is part of the RF-transceiver front-end, being implemented in a second semiconductor substrate.

In one embodiment the digital interface of the baseband device may communicate with the interface 21 of the RF-transceiver front-end according to the DIG RF Dual-Mode 2.5G/3G Baseband/RF-IC Interface Standard (DigRF), which is incorporated herein entirely by reference. The DigRF standard uses a packet-oriented communication, wherein a baseband device 20 transmits control commands to the RF-transceiver front-end and, more particularly, to a controller device 22 of the RF-transceiver front-end. In one embodiment such packets exchanged between the baseband device and the RF-transceiver front-end are referred to as telegrams. The communication between the baseband device 20 and the RF-transceiver front-end may use a bi-directional communication in one embodiment.

A telegram may specify a logical channel as, for example, set forth in the Dig-RF interface communication standard. For instance, data to be transmitted via the RF-transceiver front-end may be sent from the baseband device 20 to the controller device 22 in a first logical channel. In a different logical channel, control packets may be transmitted from the baseband device 20 to the controller device 22 of the RF-transceiver front-end. Accordingly, a telegram comprises a payload in which a control packet or a data packet may be stored.

The control packets may include commands to set the RF-transceiver into a specific mode of operation. For example, such modes may include a GSM receiving mode, a GSM transmitting mode, both specifying a channel or center frequency for data to be transmitted or received, respectively. The control packets may also comprise commands for wideband CDMA or UMTS transmission or receiving modes. Further control packets may include commands for transitioning from a first mode of operation into a second mode of operation, for instance, from a GSM receiving mode to a UMTS transmitting mode, or vice-versa.

In one embodiment the controller device 22 comprises a backbone controller 23 adapted for communicating with the baseband device 20 via the interface 21. The backbone controller 23 receives any telegram and the payload of the telegram sent by the baseband devices 20 and processes its content. The backbone controller 23 is connected to a memory 25 and to a TX or RX sequencer 26. The sequencer 26 is adapted to control the timing and provide flow control.

During initialization of the RF-transceiver front-end, a plurality of possible configuration patterns is stored in the memory device 25. In one embodiment, those configuration patterns can be uploaded from the baseband device 20 to the backbone controller 23 using telegrams with a control packet as payload. The control packet may comprise one or more configuration patterns to be stored in the memory device. The backbone controller 23 stores the configuration pattern in the memory during initialization of the RF transceiver front-end. Alternatively, the memory 25 may comprise a read-only memory wherein the plurality of configuration patterns may be stored during manufacturing.

Each of the configuration patterns corresponds to an adjustable operating state of one or more sub-circuits of the RF-transceiver front-ends. In other words, a configuration pattern may be used to adjust and set one or more sub-circuits of the RF-transceiver front-end into a desired operating state.

The controller device 23 may now receive the telegram with the control packet from the baseband device 20 via the interface 21. The control packet is processed by the backbone controller 23 of the control device 22 and the desired mode of operation as well as the desired frequency band is extracted. With the mode of operation to and the frequency band specified by the control device 22, the backbone controller 23 loads one or more configuration patterns out of the memory and buffers them in one or more registers implemented in an RF-control block 24. Accordingly, the RF-control block 24 is now able to provide the configuration patterns for the sub-circuits required for the desired mode of operation set forth by the baseband device 20.

During operation, the sequencer 26 requests a specific configuration of one or more sub-circuits of the RF-transceiver front-end. Such requests may comprise an index portion and a trigger portion. The index portion corresponds to the required configuration pattern requested by the sequencer. For instance, if an operating state of a low noise amplifier has to be changed, the index sent by the sequencer 26 corresponds to the newly required mode for the low noise amplifier. The trigger portion provides information about triggering the mode change. The index as well as the trigger portion are received by the backbone controller 23 and applied to the RF-control block 24. The RF-control block 24 now selects the corresponding configuration pattern determined by the index and provides the configuration pattern at the control pins 27 for front-end sub-circuits in response to the trigger signal.

FIG. 3 shows a schematic view of the controller device 32 having a digital communication terminal 31. The terminal 31 is connected via an interface to the baseband device (not shown herein). The controller device 32 may receive or transmit communication data via the terminal 31. For instance, a signal received by the RF-transceiver front-end is demodulated and the digital data is transmitted via the controller device 32 and the interface to the baseband device for further processing.

The control device 32 is connected to a memory 35 wherein a plurality of configuration patterns is stored. During operation, the baseband device transmits a telegram with a control packet to the controller 32 of the RF-transceiver front-end, the control packet comprising a control command requesting a specific mode of operation. The control packet with the command is processed internally by the controller device 32 and the required configuration patterns are determined. The configuration patterns 352 are then addressed via the address signal 351, loaded from the memory 35 and buffered in a register 353 implemented in the controller device 32.

The controller device 32 then transmits a time accurate strobe message (TAS message) 3,61 to a sequencer 36. The sequencer 36 uses the time accurate strobe message to generate one or more trigger events and index packets.

When the required operation is to be executed, one or more service request signals are sent to the controller 32 by the sequencer 36. A service request signal may contain an index 362 and a trigger event 363. The index 362 specifies a configuration pattern to be set at the output pins 37 at a specific time determined by the trigger event 363. Accordingly, the sequencer 36 triggers and selects the configuration pattern stored in the register of the control device 32 in response to a desired and required process flow set previously by the baseband device.

Upon requesting the configuration pattern, the control device 32 provides the required configuration pattern comprising a plurality of bits in parallel at the output interface 37. In one embodiment the configuration pattern may comprise a four bit value for addressing the sub-circuit to be adjusted and a plurality of adjustment data bits. The interface 37 is connected to the control pins for the several front-end sub-circuits. The interface used for sending the configuration pattern to the sub-circuit can be a general purpose bus (GPO-bus).

Furthermore, the sequencer 36 may send additional service request signals to the controller device 32. Such service request signals may be generated by the sequencer 36 upon request by one or more sub-circuits of the RE-transceiver front-end. Service request signals can be used to inform the controller device of a switching process between different operating states. Service request signals may also contain a request for a subsequent configuration pattern which may set the sub-circuit to the subsequent state of operation. Alternately, those service request signals can also be used in response to a process flow determined by a previous command of the baseband device. Due to the service request signals, switching between the different and subsequent states of the sub-circuits can be achieved without delay and an additional timing signal.

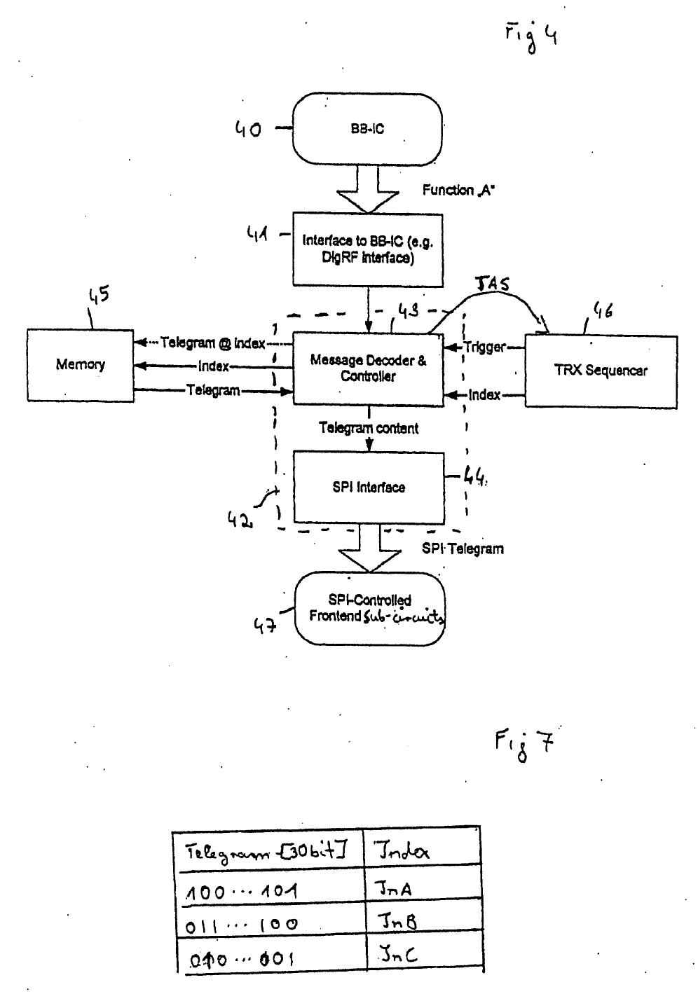

FIG. 4 illustrates a further embodiment of a communication system. In this embodiment, the plurality of sub-circuits in the RF-receiver front-end (not shown herein) are coupled to a serial bus interface for controlling and adjusting the several operating states. The bus interface may comprise an SPI bus interface using packet or telegram-oriented signals to control and adjust the sub-circuits.

The SPI bus is a serial bus system addressing one or more sub-circuits out of a plurality of sub-circuits using a serial 30 bit pattern. In one embodiment the first 13 bits of the pattern represent the address of the sub-circuit to be addressed. The next 16 bits of data comprise the control command or the adjustment signal for the addresses sub-circuit. Finally, one bit is used to enable or disable the sub-circuits. The configuration pattern is also called SPI-telegram content or SPI-telegram. An SPI-telegram content is assigned to a specific SPI-telegram, and both terms are used as equivalents for the purpose of describing the embodiments. The SPI-telegram, for instance the 30 bit data pattern, is stored in a memory 45 coupled to the controller device 42.

While the SPI bus interface and the control procedure of the sub-circuits via an SPI telegram provides a high flexibility, the telegram contents to be stored in the memory requires a higher memory usage. If such memory is not available, the number of SPI-telegrams stored in the memory has to be reduced without reducing the flexibility of the shown communication system.

The controller device 42 and particularly the message decoder & controller 43 receives one or more telegrams with control packets comprising an SPI-telegram content together with an index from the baseband device 40 via the digital interface 41. The telegram and the control packet comprise a command indicating that a payload of the telegram also comprises an SPI-telegram content to be stored in the memory. The message decoder & controller 43 processes the command and extracts the SPI-telegram content. Of course the control packet may also comprise a plurality of SPI-telegram contents to be stored. The SPI-telegrams are stored in the memory 45 before switching to the desired mode of operation.

In other words, SPI-telegram contents configuring the sub-circuits in the RF-transceiver front-end for a desired mode of operation are grouped together and transmitted from the baseband device to the message decoder & controller 43. The decoder in controller 43 stores the SPI-telegrams in the memory 45. Alternately, in one embodiment the baseband device transmits the control packets and the SPI-telegram without explicitly stating an index. Rather, the index is generated by the message decoder & controller 43 during processing of the SPI-telegram. The SPI-telegram is then saved again in the memory 45.

Upon request of switching into the desired mode of operation, the message decoder in controller 43 transmits a time-accurate strobe message TAS to the sequencer 46. The sequencer 46 executes the process flow for the desired operation mode and starts transmitting index and trigger signals to the message decoder & controller 43. The decoder 43 uses the index signal to load an assigned telegram from the memory 45. The telegram content is sent to the SPI interface 44 and converted into an SPI telegram.

Accordingly, the SPI-telegrams themselves used for adjusting and configuring the sub-circuits in the RF-transceiver front-end are triggered and loaded autonomously without sending or receiving additional control packets via the interface 41 from the baseband device 40. Such semi-automatism of the RF-transceiver device relaxes the requirements for sending time-accurate control packets or data packets via the digital interface 41.

If a different mode of operation is to be selected, for example a transition from a GSM transmission mode to a UMTS reception mode, a new plurality of SPI-telegrams are transmitted by the baseband device 40 via telegrams and control packets to the controller device 42 of the RF-transceiver front-end. The message decoder & controller 43 extracts the SPI-telegrams within the control packets. An index is assigned to the SPI-telegrams and the SPI-telegrams and indexes are stored in the memory 45. The new mode of operation can then be activated upon request by the baseband device 40. As a result, the controller 43 is configured to exchange and overwrite one or more telegrams upon request from the baseband device 40.

In the embodiment according to FIG. 4, the baseband device 40 may only transmit a short SPI-telegram content corresponding to the 16 bits of configuration data and a value indicating the sub-circuit to be addressed. The message decoder & controller 43 may derive from the value the address of the corresponding sub-circuit and stores the address together with the configuration data in the memory. Such procedure may be useful if the baseband device does not “know” the correct address of the corresponding sub-circuits in the RF-transceiver front-end. Alternatively, the baseband device 40 may generate a control packet for transmission to the controller device 42, the control packet comprising the whole SPI telegram which is used for configuration of the sub-circuits during operation.

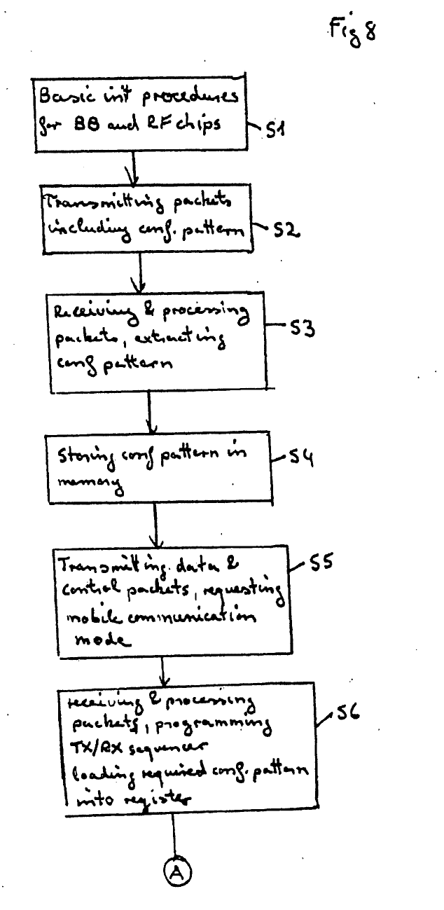

FIG. 7 shows an example of a memory wherein a plurality of SPI-telegrams are stored together with an index assigned thereto according to one embodiment. Each SPI-telegram comprises 30 bits wherein 13 bits may address the sub-circuit to be configured while 16 bits are used to configure the addressed sub-circuit. A further bit is used to indicate enable/disable. The index assigned to the SPI-telegram can be the memory address of the corresponding SPI-telegram. Upon request by the sequencer 46, the message decoder & controller 43 addresses the memory 45 and loads the telegram found at the address to the SPI interface 44.

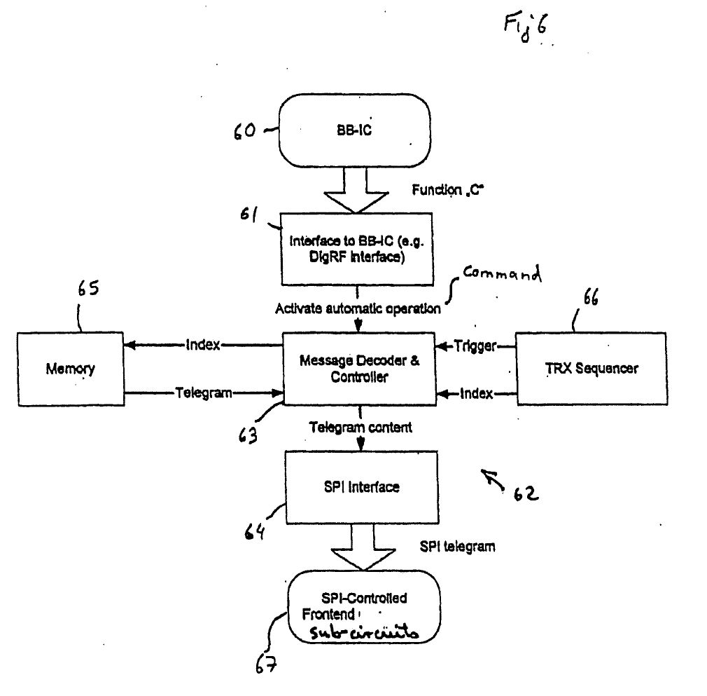

It may also be useful if one or more sub-circuits of the RF-transceiver front-end can be controlled directly by the baseband device. Such embodiment is shown in FIG. 5. The communication system 5a according to FIG. 5 comprises a baseband device 50 coupled to the digital interface 51. The digital interface is connected to the controller device 52 and particularly to a message decoder & controller 53 being part of the controller device 52.

In operation, the baseband device 50 may transmit a control packet to the interface 51 of the RF-transceiver front-end. The control packet may include an SPI-telegram used for configuring one or more sub-circuits of the RF-transceiver front-end. The control packet is received by the message decoder & controller 53 of the controller device 52 and processed therein. The SPI-telegram content is extracted from the control packet and forwarded to the SPI interface 54. The SPI interface 54 generates a corresponding SPI telegram and transmits the telegram to the SPI controlled front-end components 57 of the RF-transceiver front-end. These components may comprise one or more sub-circuits of the RF-transceiver.

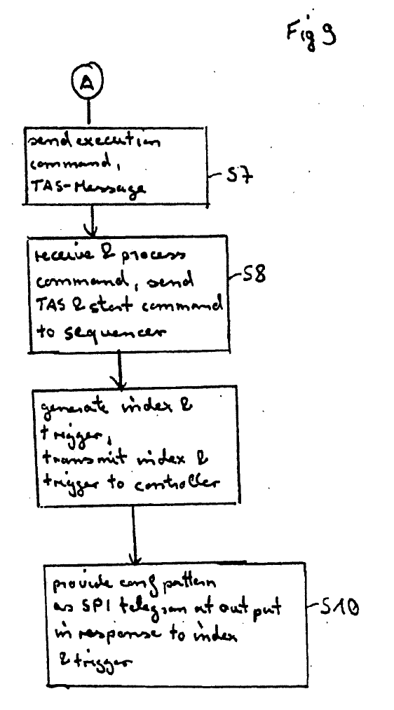

FIG. 8 shows an embodiment of a method for configuring and adjusting an RF transceiver front-end for signal transmission or reception. Although the method is illustrated and described below as a series of acts or events, it will be appreciated that the present invention is not limited by the illustrated ordering of such acts or events. For example, some :acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the devices and systems illustrated and described herein as well as in association with other structures not illustrated.

In one embodiment, a communication system is provided having a baseband device and a transceiver front-end. The baseband device and the transceiver front-end may communicate with each other via a digital interface using the DigRF interface standard in one embodiment.

At S1, the basic initialization procedures for the baseband device and the transceiver front-end are executed. In one embodiment those procedures may comprise activating supply and current generators, initializing basic subroutines and activating the controller in the baseband device and the RF transceiver front-end for communicating and exchanging data. Furthermore, some self tests and autonomous adjustment procedures are executed during the initialization procedure. For instance, deviation in a carrier signal generation due to temperature dependent behavior is measured and determined. The deviation can then be compensated by generating corresponding adjustment signals automatically. Such compensation in the transceiver front-end can be achieved without any control from the baseband device.

After the basic initialization procedures, the base band device transmits a plurality of control telegrams to the RF transceiver front-end at S2. The control telegrams comprise a command indicating that a portion of the control telegrams includes one or more configuration patterns for a specific mode of operation, which will be required later on. In other words, the control packets comprise configuration patterns for adjusting the transceiver front-end components, wherein the patterns are used in at least one mode of operation later on. The configuration pattern may comprise a SPI telegram.

For instance, if a specific transmitter mode will be used at a later stage, the control telegrams may comprise a configuration pattern for adjusting the power amplifier, the phase locked loop in the transmitter path and the filter in the transmitter path. In one embodiment the configuration pattern used for adjusting and switching for the later required mode of operation are selected and transmitted.

At S3 the control telegrams are received and processed by the controller of the transceiver front-end. The controller extracts the configuration pattern from the data payload of the transmitted control telegram and assigns an index to the configuration pattern. With use of the index the controller is able to later identify the configuration pattern required by the sequencer of the transceiver front-end. At S4 the configuration pattern together with the assigned index is stored in the memory. In this respect, the index may comprise a specific address of the memory in which the corresponding configuration pattern is stored. When loading the configuration pattern from the memory, the controller may select the specific address on which the desired configuration pattern is stored.

After all configuration patterns for the afterwards required mode of operation are stored in the memory, the baseband device may start transmitting one or more data telegrams including data to be transmitted according to the desired mode of operation at S5. Further control telegrams are generated in the baseband device, the control telegrams requesting a specific mobile communication mode. For instance, if data are to be transmitted according to a GSM mobile communication standard, the baseband device generates data telegrams with the data to be transmitted and at least one control telegram requesting a GSM transmission mode with a specific channel and a specific output power from the transceiver front-end.

However, since the corresponding configuration pattern adjusting all sub-circuits of the RF transceiver front-end for this mode of operation are transmitted and stored in the memory previously, the requirements for a time critical sequence flow are relaxed. Further, the control device of the transceiver front-end “knows” the desired mode of operation of the transceiver front-end. The sub-circuits of the transceiver front-end only require specific adjustment states without precise knowledge of the desired mode of operation.

Consequently, the control device of the transceiver front-end copies at S6 the required configuration patterns from the memory into a register for faster access. It further programs a TX/RX sequencer of the transceiver front-end used for controlling the sequence flow.

At S7 of FIG. 9 all preparations by the transceiver front-end are finished. The baseband device may now send an execution command including a TAS message indicating a specific time stamp, for controlling a data transmission. The TAS message (time accurate strobe message) is received at S8 by the controller device of the transceiver front-end and processed. The TAS message indicates a starting time and provides information about the data transmission flow. The TAS message is forwarded by the control device to the TX/RX sequencer for starting and controlling the transmission.

Accordingly, the TX/RX sequencer generates one or more indexes and trigger events and transmits the generated indexes and trigger events to the control device. The generation and transmission of those trigger events are dependent and derived from the TAS message. Upon reception of an index and trigger at S10, the control device of the transceiver front-end provides the configuration pattern stored previously in the register and assigned to the respective index as an SPI telegram at the output. The trigger event provided by the sequencer is used to determine the time for providing the configuration pattern and sending the SPI telegram to the corresponding sub-circuit for adjustment.

During sequencing, the sequencer provides a plurality of index and trigger events until the whole sequence is finished or the baseband device sends a different command terminating the sequence and switching to a different mode of operation.

FIG. 6 shows a further embodiment of a communication system. The communication system comprises a baseband device 60 implemented in a first semiconductor chip and a second RF-transceiver front-end implemented in a second semiconductor chip. The baseband device 60 is coupled to the RF-transceiver front-end via the digital interface 61. The RF-transceiver front-end comprises a controller device 62 including a message decoder & controller 63 and a SPI interface 64. The message decoder & controller 63 is coupled to a memory 65 and to a TX/RX sequencer for controlling process flow. A plurality of SPI-telegrams including an index assigned to it is stored in the memory 65. The SPI-telegrams are used to control at least one sub-circuit of the RF-transceiver front-end. This sub-circuit can be a specific sub-circuit, for instance, the only component of the RF-transceiver front-end which can be controlled by an SPI-telegram. In such case, the corresponding telegrams configuring that component can be stored completely in the memory 65 without the requirement for loading and overwriting previously stored telegrams due to a small memory size.

In operation, the baseband device 60 transmits a command activating an automatic operation to the message decoder & controller 63. After the automatic operation is activated, the RF-transceiver's sequencer 66 request SPI-telegrams from the message decoder & controller 63 by use of an index and a corresponding trigger event. The message decoder & controller 63 loads the telegram from the memory in response to the index and provides the SPI-telegram content at the SPI interface in response to the trigger event. The SPI interface transmits the SPI telegram to the SPI-controlled front-end components 67 of the RF-transceiver front-end.

In all embodiments, the requirements for a time-accurate signal for controlling the corresponding sub-circuits of the transceiver front-end are relaxed due to a semi-autonomous and separate processing within the transceiver front-end itself. Accordingly, the baseband device does not need to transmit control packets including configuration commands to the transceiver front-end in a timely accurate manner. Rather, the desired configurations can be stored previously in a memory of the transceiver front-end and then executed upon request by the transceiver sequencer itself.

The different features of the embodiments shown herein can be combined by one skilled in the art to achieve one or more advantages of the present invention. Although specific embodiments have been illustrated and described, it will be appreciated by one of ordinary skill in the art that any arrangement which is made to achieve the same purpose may be substituted for the specific embodiment shown. It is to be understood that the above description is intended to be illustrative and not restrictive. The application is intended to cover any variations of the invention. The scope of the invention includes any other embodiments and applications in which the above structures and methods may be used. The scope of the invention should therefore be determined with reference to the appended claims along with the scope of equivalence to which such claims are entitled.

It is emphasized that the abstract is provided to comply with 37 CFR. Section 1.72(b) requiring an abstract that will allow the reader to quickly ascertain the nature and gist of a technical disclosure. It is submitted with the understanding that it will not be used to interpret or limit the scope of meaning of the claims.

1. A transceiver with a plurality of sub-circuits, comprising:
an interface configured to receive control packets, wherein the control packets specify at least one mode of operation of the transceiver;
a memory configured to store a first plurality of configuration patterns, wherein at least one configuration pattern of the first plurality of configuration patterns is operable to configure the transceiver for the at least one mode of operation;
a control interface coupled to the plurality of sub-circuits;
a decoder coupled to the interface and to the memory, wherein the decoder is adapted to retrieve the at least one configuration pattern from the memory in response to the control packet, and provide the at least one configuration pattern to the control interface.

2. The transceiver of claim 1, wherein the at least one configuration pattern comprises a first plurality of bits specifying at least one sub-circuit of the plurality of sub-circuits to be addressed, and a second plurality of bits configuring the sub-circuit addressed by the first plurality of bits.

3. The transceiver of claim 1, wherein the decoder comprises a register, wherein the register is adapted to store a second plurality of configuration patterns retrieved from the memory in response to the control packet.

4. The transceiver of claim 3, wherein the decoder is adapted to provide one configuration pattern out of the second plurality of configuration patterns at the control interface in response to a trigger signal.

5. The transceiver of claim 1, wherein the decoder is configured to store at least one configuration pattern in the memory, and wherein the control packet comprises the at least one configuration pattern.

6. The transceiver of claim 5, wherein the control packet comprises a synchronization field, a header field and a payload data field, and wherein the payload data field comprises the at least one configuration pattern.

7. The transceiver of claim 1, wherein the at least one configuration pattern is assigned to an index, wherein the at least one configuration pattern is retrievable by use of the index.

8. The transceiver of claim 1, further comprising a sequencer device, coupled to the decoder, wherein the decoder is adapted to provide a configuration pattern at the control interface in response to a trigger signal and an index provided by the sequencer device, the index identifying the configuration pattern.

9. A RF transceiver, comprising:
a plurality of circuit elements configured to receive and/or transmit a RF signal, wherein at least one of the circuit elements is adjustable in response to an adjustment signal;
a register configured to store a first plurality of configuration patterns, wherein at least one configuration pattern of the first plurality of patterns specifies an adjustment of the at least one circuit element; and
a controller coupled to the register and adapted to retrieve the at least one configuration pattern in response to a request signal, and provide the adjustment signal based on the at least one configuration pattern.

10. The RF transceiver of claim 9, further comprising a memory configured to store a second plurality of configuration patterns, the second plurality of configuration patterns comprising the first plurality of configuration patterns.

11. The RF transceiver of claim 10, wherein the controller is adapted to copy the first plurality of configuration patterns from the memory to the register in response to an external control signal applied to the controller.

12. The RF transceiver of claim 9, wherein the request signal comprises a trigger portion and an index portion, and wherein the controller is adapted to elect the at least one configuration pattern in response to the index portion and the adjustment signal in response to the trigger portion.

13. The RF transceiver of claim 9, wherein the request signal is provided by at least one of the circuit elements of the plurality of circuit elements.

14. The RF transceiver according to claim 9, further comprising a sequencer device coupled to the controller and adapted to control sequencing by providing the request signal.

15. A RF transceiver, comprising:
an interface configured to receive a control packet, wherein the control packet comprises at least one configuration pattern;
a plurality of circuit elements configured to receive and/or transmit a RF signal, wherein at least one of the circuit elements is adjustable in response to an adjustment signal;
a memory configured to store a plurality of configuration patterns, wherein at least one configuration pattern of the plurality of configuration patterns specifies an adjustment of the at least one circuit; and
a controller coupled to the memory and to the interface, wherein the controller is adapted to receive the control packet and store the at least one configuration pattern in the control packet in the memory.

16. The RF transceiver of claim 15, wherein the controller is adapted to retrieve the at least one configuration pattern from the memory in response to a request signal, and provide the adjustment signal based on the at least one configuration pattern.

17. The RF transceiver of claim 15, wherein the request signal comprises an index portion and a trigger portion, and wherein the controller is adapted to provide the adjustment signal in response to the trigger portion.

18. The RF transceiver of claim 15, wherein the controller is adapted to generate an index assigned to the at least one configuration pattern and store the index in the memory.

19. The RF transceiver of claim 15, wherein the control packet comprises a header portion and a data payload, wherein the data payload comprises the at least one configuration pattern to be extracted by the controller and stored in the memory.

20. A method for adjusting a transceiver, the transceiver comprising at least one adjustable sub-circuit, the method comprising:
providing a first control packet, the first control packet comprising at least one configuration pattern for adjusting the transceiver to a mode of operation;
receiving the control packet;
storing the at least one configuration pattern from the first control packet in a memory;
providing a second control packet, the second control packet comprising a command to select the mode of operation;
loading the at least one configuration pattern from the memory in response to the command in the second control packet; and
adjusting the transceiver in response to at least-one configuration pattern.

21. The method of claim 20, wherein adjusting the RF transceiver comprises generating a telegram having a plurality of bits, and sending the telegram to the at least one adjustable sub-circuit.

22. The method of claim 20, wherein providing a second control packet comprises:
generating a time accurate strobe message; and
receiving the second control packet and the time accurate strobe message at the transceiver.

23. The method of claim 20, wherein loading the at least one configuration pattern comprises:
generating an index, the index identifying the at least one configuration pattern; and
addressing the at least one configuration pattern in response to the index.

24. The method of claim 20, wherein storing the at least one configuration pattern comprises:
generating an index assigned to the at least configuration pattern; and
storing the at least one configuration pattern together with the index in the memory.

25. The method of claim 20, wherein storing the at least one configuration pattern comprises replacing a previously stored configuration pattern in the memory with the at least one configuration pattern.
